(19) United States
(12) Patent Application Publication
(10) Pub. No.: US 2015/0302424 A1
(43) Pub. Date: Oct. 22, 2015

(54) SYSTEMS AND METHODS FOR PROVIDING CONTENT PROVIDER-DRIVEN SHOPPING

(71) Applicant: MAVATAR TECHNOLOGIES, INC., Menlo Park, CA (US)

(72) Inventors: Susan Akbarpour, Menlo Park, CA (US); Brian Bahram Mahbod, Menlo Park, CA (US)

(73) Assignee: MAVATAR TECHNOLOGIES, INC., Menlo Park, CA (US)

(21) Appl. No.: 14/256,720

(22) Filed: Apr. 18, 2014

(51) Int. Cl. G06Q 30/02; G06Q 30/06

(52) U.S. Cl. CPC G06Q 30/0201; G06Q 30/0633; G06Q 30/0214

(57) ABSTRACT

Systems and methods for providing content provider-driven shopping are disclosed. A system may include a processor and a non-transitory, processor-readable storage medium. The non-transitory, processor-readable storage medium may include one or more programming instructions that, when executed, cause the processor to receive content from a provider via a content publishing platform, determine one or more products from the content, for each product, determine one or more merchants offering the product for sale and determine a price for the product from each merchant, determine one or more discounts or incentives offered by each merchant, and, for each product, select a merchant of the one or more merchants based on the price for the product from the merchant and the one or more discounts or incentives offered by the merchant.

### BACKGROUND

Electronic commerce (e-commerce) has enjoyed expansive growth in recent years. Today, many consumers shop with merchants over the Internet from any location rather than physically going to a store. While a consumer may not be able to physically handle a product while shopping on the Internet, the consumer may have the opportunity to view pictures and/or videos of the product, view textual, audio, video, and graphical descriptions of the product, view professional or crowd sourced descriptions of the product, as well as read reviews and/or recommendations for the product. Because of the overwhelming amount of options available on the Internet, some consumers may desire to receive product recommendations, receive push notifications, or use filters and sorting options to determine their options when buying.

Content providers, such as writers, bloggers, personal shoppers, and the like are increasingly able to provide product recommendations to consumers, including customized product recommendations. Certain content providers may desire to create collections of products from multiple merchants (for example, on a particular trend, style, season, and/or the like). Because each merchant has a unique collection of products, a particular price for a product, particular discounts, particular incentives, and/or the like, it can be cumbersome and difficult for a content provider to determine which merchant to use for a particular product.

Content providers may also balk at the notion of providing one or more links to products in their content because such links will drive a consumer away from the provider's content with a high likelihood that the consumer will not return to the provider's content after clicking the link. Previous attempts to solve this problem have included putting links to products at the end of an online publication so that the consumer reviews all of the content before clicking the link. However, such a method may still prevent the consumer from returning to the content to click on other links, which in turn may be disadvantageous for a plurality of reasons, such as, for example, diminished advertising or click-through revenue.

### SUMMARY

In an embodiment, a system may include a processor and a non-transitory, processor-readable storage medium. The non-transitory, processor-readable storage medium may include one or more programming instructions that, when executed, cause the processor to receive content from a provider via a content publishing platform, determine one or more products from the content, for each product, determine one or more merchants offering the product for sale and determine a price for the product from each merchant, determine one or more discounts or incentives offered by each merchant, and, for each product, select a merchant of the one or more merchants based on the price for the product from the merchant and the one or more discounts or incentives offered by the merchant.

In an embodiment, a method may include receiving, by a processor, content from a provider via a content publishing platform, determining, by the processor, one or more products identified in the content, for each product, determining, by the processor, one or more merchants offering each product for sale and determining, by the processor, a price for the product from each merchant, determining, by the processor, one or more discounts or incentives offered by each merchant, and, for each product, selecting, by the processor, a merchant from the one or more merchants based on the price for the product from the merchant and the one or more discounts or incentives offered by the merchant.

In an embodiment, a system may include a processor and a non-transitory, processor-readable storage medium. The non-transitory, processor-readable storage medium may include one or more programming instructions that, when executed, cause the processor to provide a shopping list of one or more products. Each of the one or more products may correspond to a product identified in published content and each of the one or more products may be selected from a particular merchant offering the product at a lowest price based on a final price and one or more discounts or incentives. The non-transitory, processor-readable storage medium may further include one or more programming instructions that, when executed, cause the processor to receive one or more product selections from the shopping list; provide a unified shopping cart containing the one or more product selections; and, for each product, provide access to the particular merchant's checkout functions with the one or more discounts or incentives pre-applied.

In an embodiment, a method may include providing, by a processor, a shopping list of one or more products. Each of the one or more products may correspond to a product identified in published content and each of the one or more products may be selected from a particular merchant offering the product at a lowest price based on a final price and one or more discounts or incentives. The method may further include receiving, by the processor, one or more product selections from the shopping list; providing, by the processor, a unified shopping cart containing the one or more product selections; and, for each product, providing, by the processor, access to the particular merchant's checkout functions with the one or more discounts or incentives pre-applied.

### BRIEF DESCRIPTION OF THE DRAWINGS

FIG. 1 depicts an illustrative diagram of a system for providing content provider-driven shopping according to an embodiment.

FIG. 2 depicts a schematic diagram illustrating and providing an overview of an online purchasing and account management system according to an embodiment.

FIG. 3 depicts a flow diagram of an illustrative browsing, optimization, and purchasing process with merchants via the content provider-driven shopping system according to an embodiment.

FIG. 4 depicts a flow diagram of an illustrative method of registering a content provider and publishing content according to an embodiment.

FIG. 5 depicts a flow diagram of an illustrative method of determining one or more products from published content according to an embodiment.

FIG. 6 depicts a flow diagram of an illustrative method of providing content provider-driven shopping according to an embodiment.

FIG. 7 depicts a flow diagram of an illustrative data management process according to an embodiment.

FIG. 8 depicts a flow diagram of an illustrative email registration, management, and optimization process according to an embodiment.

FIG. 9 depicts a flow diagram of an illustrative method of using purchased coupons, discounts, loyalty points, gift cards, store credits, and/or promotions according to an embodiment.

FIG. 10 depicts a block diagram of an illustrative computing system according to an embodiment.

FIG. 11 depicts a screen shot of an illustrative “Collection ID” link according to an embodiment.

FIG. 12 depicts a screen shot of illustrative content provided by a content provider according to an embodiment.

FIG. 13 depicts a screen shot of an illustrative store containing access to collections according to an embodiment.

FIG. 14 depicts a screen shot of illustrative collections within a store that a user may use to access content provided by a content provider according to an embodiment.

FIG. 15 depicts a screen shot of an illustrative dashboard for a content provider to access according to an embodiment.

FIG. 16 depicts a detailed view of an illustrative amount of sales for each collection provided by a content provider according to an embodiment.

FIG. 17 depicts a screen shot of an illustrative content page containing a publisher page link according to an embodiment.

FIG. 18 depicts a screen shot of an illustrative publisher page containing a content provider's collections according to an embodiment.

FIG. 19 depicts a screen shot of an illustrative collection creation page according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “user” refers to one or more entities or people using any of the components and/or elements thereof as described herein. In some embodiments, the user may be a user of an electronic device. In other embodiments, the user may be a user of a computing device. Users described herein are generally either creators of content, managers of content, merchants, or consumers. For example, a user can be an administrator, a developer, a group of individuals, a content provider, a consumer, a merchant, a representative of another entity described herein, and/or the like. In some embodiments, a user who initially registers with the system described herein may be a general user, such as a consumer. A user may further be elevated to content provider status upon applying for and receiving permission from an administrator, as described in greater detail herein.

An “electronic device” refers to a device that includes a processor and a tangible, computer-readable memory or storage device. The memory may contain programming instructions that, when executed by the processing device, cause the device to perform one or more operations according to the programming instructions. Examples of electronic devices include personal computers, supercomputers, gaming systems, televisions, mobile devices, medical devices, recording devices, and/or the like.

A “mobile device” refers to an electronic device that is generally portable in size and nature or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, and the like.

A “computing device” is an electronic device, such as a computer, a processor, a memory, and/or any other component, device or system that performs one or more operations according to one or more programming instructions.

A “user interface” is an interface which allows a user to interact with a computer or computer system. A user interface may generally provide information or data to the user and/or receive information or data from the user. The user interface may enable input from a user to be received by the computer and may provide output to the user from the computer. Accordingly, the user interface may allow a user to control or manipulate a computer and may allow the computer to indicate the effects of the user's control or manipulation. The display of data or information on a display or a graphical user interface is a non-limiting example of providing information to a user. The receiving of data through a keyboard, mouse, trackball, touchpad, pointing stick, graphics tablet, joystick, gamepad, webcam, headset, gear sticks, steering wheel, pedals, wired glove, dance pad, remote control, and accelerometer are non-limiting examples of user interface components which enable the receiving of information or data from a user.

An “item”, a “product”, “merchandise” are all goods and/or services that may be available for purchase. For example, the item, product, or merchandise may be an article of clothing, a fashion accessory, a household good, an electronic device, a car, a flight, a hotel reservation, an event ticket, property, and/or any other good or service. Items, products, merchandise are generally used interchangeably herein, and therefore a discussion of one or more of the terms is meant to include any or all of the terms.

A “coupon”, a “discount”, a “store credit”, a “gift card”, a “reward”, a “loyalty program”, a “points program”, a “promotion”, and an “incentive” are all generally instruments used by a consumer to obtain a good from a merchant at a price that is less than the merchant's advertised price. In some embodiments, the instruments may provide a consumer with an additional item in lieu of a lesser price. Coupons, discounts, store credits, gift cards, rewards, loyalty programs, points programs, promotions, and incentives are generally used interchangeably herein, and therefore a discussion of one or more of the terms is meant to include any or all of the terms.

The present disclosure relates generally to systems and methods for providing a content provider with an ability to link one or more products to his/her content and/or provide the content provider with a means for providing his/her content to any other person or entity. The one or more products may generally be referenced in the content and may be organized such that a consumer that consumes the content is not directed away from the content to make a purchase. Rather, the consumer is provided with an opportunity to view a collection of the products and/or purchase all of the one or more products at a unified location and/or within the context of the provider's content, while also ensuring the consumer is provided with the best available personalized price for each of the products. In addition, the systems and methods described herein may provide referral incentives to the content providers for referring the consumers to particular merchants and/or enticing consumers to purchase particular products, as well as referring other content providers who respectively refer additional consumers.

The systems and methods described herein may further allow a consumer to discover, collect, aggregate, collect, optimize, and automatically apply any coupons, rewards, gift cards, loyalty programs, and/or the like (collectively referred to as “Value Elements” or “VEs”) in real time at the point of purchase. Via the VEs, the systems and methods may allow for substantial efficiencies to the online retail business by increasing value for the consumer while simultaneously reducing the cost of goods sold. The systems and methods may also allow for reduced accounting liabilities for the merchants (for outstanding VEs) and increased promotion redemption rate and sales volume. As such, merchants may increase profits and be better equipped to properly compensate content providers that refer the consumer to the merchant.

In some embodiments, the systems and methods described herein may obtain information by observing, obtaining, and/or recording user interactions. For example, the systems and methods described herein may record a popularity of an item. The popularity may be based upon, for example, the number of times a content provider adds the item to a cart or a collection. Thus, an item that is added to a plurality of collections by a plurality of content providers may be more popular than an item that is not added to a collection or only added to one collection. The popularity may also be based upon, for example, a number of times the item is purchased, regardless of the merchant that sold the item. Further, the popularity might be based on other users “complimenting” a user for adding a particular item to a collection and/or a cart. Other user interactions that may be recorded by the systems and methods described herein include, but are not limited to, a number of users that access a content provider's content, a number of users that purchase items from a content provider's content, a number of users that share a content provider's content and/or an item with another user, a user's rating of a content provider and/or the content provider's content, a number of times an item has been viewed, and/or the like. Those with ordinary skill in the art will recognize additional user interactions that may be observed and/or recorded that are not explicitly described herein. This disclosure is meant to include such interactions. In some embodiments, the systems and methods described herein may be configured to provide a searchable database containing the obtained information. Such a searchable database may allow a user to determine, for example, popular items, popular content providers, and/or the like.

In some embodiments, the systems and methods described herein may provide a marketplace containing a plurality of items that are offered for sale by one or more merchants. Thus, for example, the marketplace may be an aggregation of items that are offered for sale by merchants. Such a marketplace may provide a user with an ability to quickly browse for, search, and/or discover an item. The marketplace may further provide the user with a list of merchants that offer the item for sale, available discounts for the item, and/or the like, as described in greater detail herein. For users such as content providers, the marketplace may provide the user with an ability to feature an item in a print, digital content, video content, and/or audio content, such as a collection and/or the like, as described herein. The marketplace may be searchable, such as by name, keyword, price, type of collection, type of item, whether a content provider has added the item to his/her content, whether the item is popular, and/or the like. The marketplace may provide a user with an ability to search for all collections of a content provider, detailed descriptions of a content provider, and links back to the content provider's website and/or content.

The systems and methods described herein may offer a consumer a straight-forward, non-obtrusive mechanism for making single- and multi-item online shopping easy and painless, particularly for items suggested by a content provider. Furthermore, the consumer may be assured that all promotions the consumer is entitled to have been automatically considered. In addition, the systems and methods described herein may allow for a consumer to discover products he/she would not have considered or been aware of by empowering content providers to publish content-containing links to the products and/or collections of products.

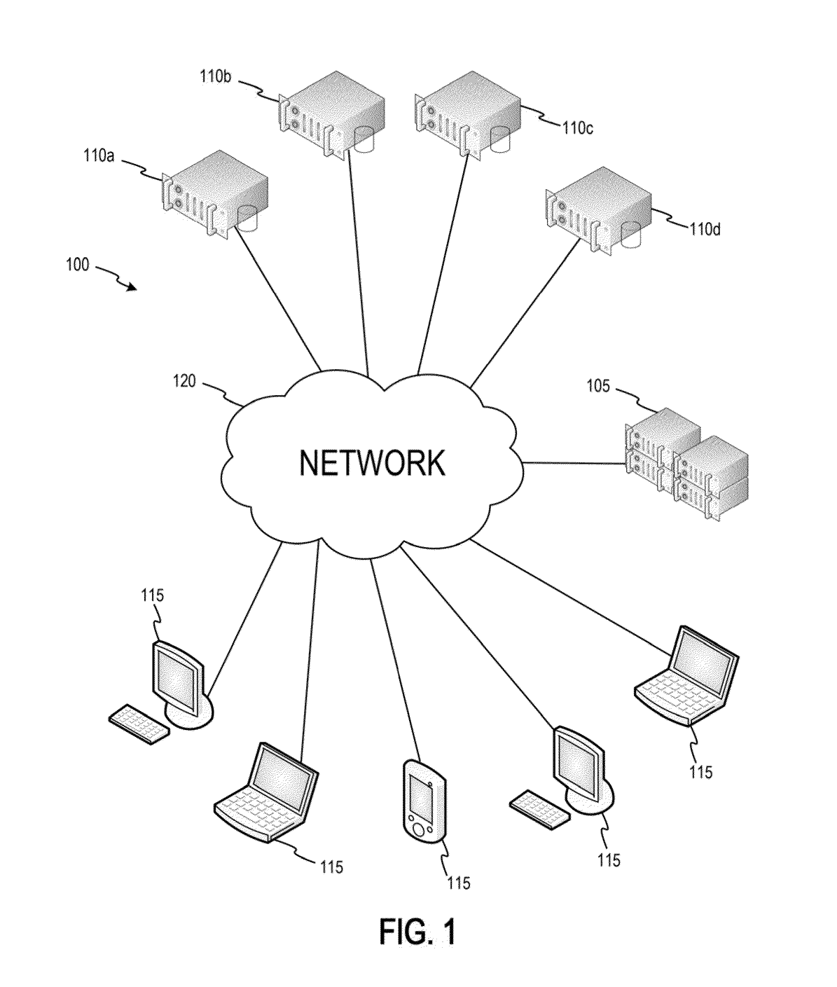

FIG. 1 depicts an illustrative system, generally designated 100, for providing content according to an embodiment. Various references to the system 100 herein may be to the system as a whole, or one or more of its constituent parts. The system 100 may generally be a plurality of devices that are interconnected via a network 120, such as the Internet or one or more direct connections. In various embodiments, a computing device 105 may provide an interface for one or more users. The computing device 105 may contain a back-end module. The back-end module may include, but is not limited to, a coupon management module, a privacy patrol module, a profile management module, and a dashboard module.

The one or more users may connect to the computing device 105 via an electronic device 115. The electronic device 115 may generally be a user's personal electronic device, such as a smartphone, a tablet, a computer, and/or the like. The electronic device 115 may contain one or more applications (“apps”) that are used to provide content, connect to the computing device 105, and/or connect to a merchant computing device 110a-110d (collectively, 110). Illustrative apps may include, for example, a browser plugin, a software application, and/or the like. At least a portion of the computing device 105 and/or the electronic device 115 may host a front end module that interacts with each user via the one or more apps.

The merchant computing device 110 may generally be a device that is owned, controlled, directed, and/or operated by a merchant to sell one or more products. For example, a merchant computing device 110 may be a computer server that hosts a merchant's website. The merchant computing device 110 may include a retail platform, a module for accepting coupons, discount codes, and/or the like, a module for conducting sales, and/or the like. The merchant computing device 110 may also include an intelligence module that may work in conjunction with the computing device 105 to obtain intelligence on each user. For example, the intelligence module may monitor and/or analyze a user's behavior and/or the like. Those having ordinary skill in the art will recognize other features and aspects of the merchant computing device 110 not explicitly described herein.

In some embodiments, particularly as shown in FIG. 1, the electronic device 115 may connect to the computing device 105 through a network 120 such as the Internet. In other embodiments, the electronic device 115 may connect to the computing device 105 via a direct connection. The direct connection is not limited by this disclosure and may generally be any direct connection now known or later developed, including wired and wireless direct connections. In other embodiments, the electronic device 115 may connect to the computing device 105 via a networked connection other than the Internet.

The computing device 105 and/or the electronic device 115 may also connect to the one or more merchant computing devices 110. In some embodiments, the computing device 105 and/or the electronic device 115 may connect to the one or more merchant computing devices 110 through the network 120. In other embodiments, the computing device 105 and/or the electronic device 115 may connect to the one or more merchant computing devices 110 via one or more direct connections. In other embodiments, the computing device 105 and/or the electronic device 115 may connect to the one or more merchant computing devices 110 via a networked connection other than the Internet.

As will be described in greater detail herein, the computing device 105 may be configured to receive content from one or more content providers, determine one or more products identified in the content, access the one or more merchant computing devices 110 to determine whether each merchant offers any of the one or more products, determine a price for the one or more products offered by each merchant, determine any discounts and/or incentives offered by each merchant, and provide a unified shopping cart ready to transact and confirm the purchase with pre-populated shopper's personal information such as name, address, loyalty and payment information, and/or the like to the user. If a user selects a product to purchase, the computing device 105 may provide a direct connection between the electronic device 115 used by the user and the merchant computing device 110 for completion of the transaction.

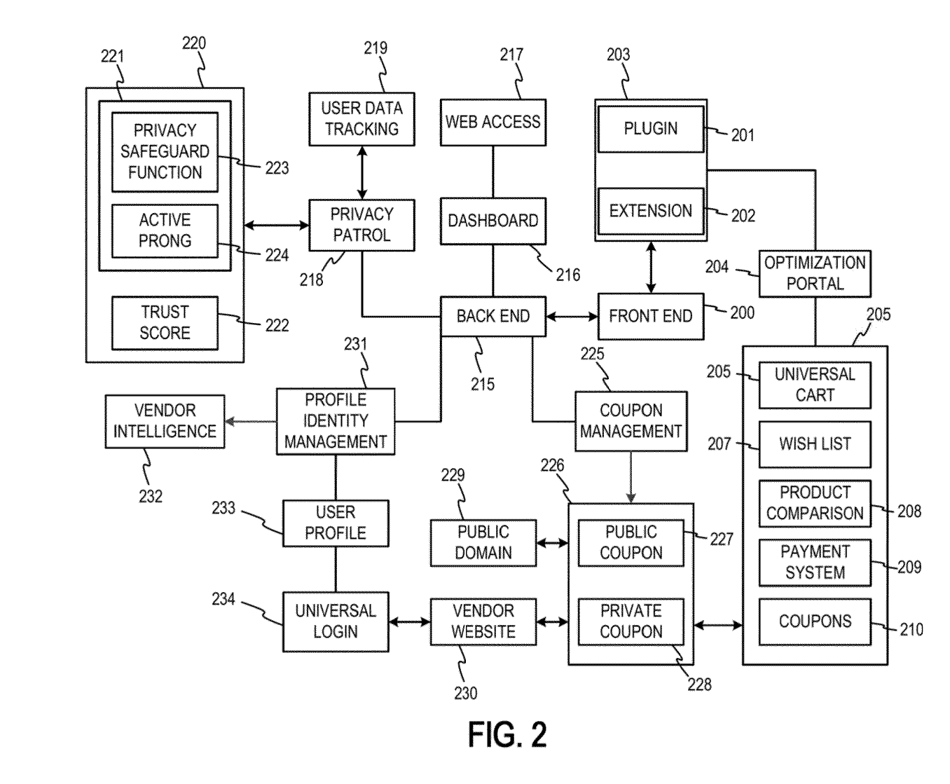

FIG. 2 depicts a schematic diagram illustrating and providing an overview of an online purchasing and account management system according to an embodiment. On a front end 200, a user may download and install an application, such as, for example, a browser plugin 201, an app, or the like that will provide an extension 202 of the system on the user's electronic device 203, such as the user's computer, the user's smartphone, the user's tablet, and/or the like. A user may use the application, via an optimization portal 204, to access an optimization system 205. The optimization system 205 may include, for example, a universal cart module 206, a wish list module 207, a product comparison module 208, a payment system module 209, and a coupons application module 210.

In various embodiments, on a back end 215, the user, via a dashboard 216, may access the computing device via a network, such as, for example, via web access 217. A privacy patrol module 218 may also be included on the back end 215. The privacy patrol module 218 may be configured to track user data 219. For example, the privacy patrol module 218 may track links clicked by a user, content viewed by a user, products viewed by a user, purchases made by a user, and/or the like. In some embodiments, a security and privacy system 220 may be included as a portion of the privacy patrol module 218. The security and privacy system 220 may include a user security module 221 and a trust score module 222. The user security module 221 may include a privacy safeguard function 223, which may access a likelihood of whether a merchant is leaking user data to others. The user security module 221 may also include an active prong 224, which may allow the system to release “realistic but fake” data records to further improve the chances of detecting leakage and identifying the merchant that is responsible for compromising user data. In some embodiments, the trust score component 222 of the security and privacy system 220 may provide a user with a score indicating the trustworthiness of a particular web site.

In various embodiments, a user also may have access to a coupon management module 225 on the back end 215. The coupon management module 225 may allow the user to access one or more coupons 226, including public coupons 227 and/or private coupons 228. The public coupons 227 may generally be coupons retrieved from the public domain 229, whereas the private coupons 228 may generally be coupons targeted by a merchant for a particular user, such as, for example, via the merchant's web site or email list 230.

In various embodiments, a user may also have access to a profile and identity management module 231 on the back end 215. The profile and identity management module 231 may provide a merchant with user data intelligence 232. The user may also access his/her user profile 233 via the profile and identity management module 231, which may provide access to a universal login 234. In some embodiments, the user may control his/her information on the merchant's web site 230 via the universal login 234, thereby controlling one or more private coupons 228 received from the merchant.

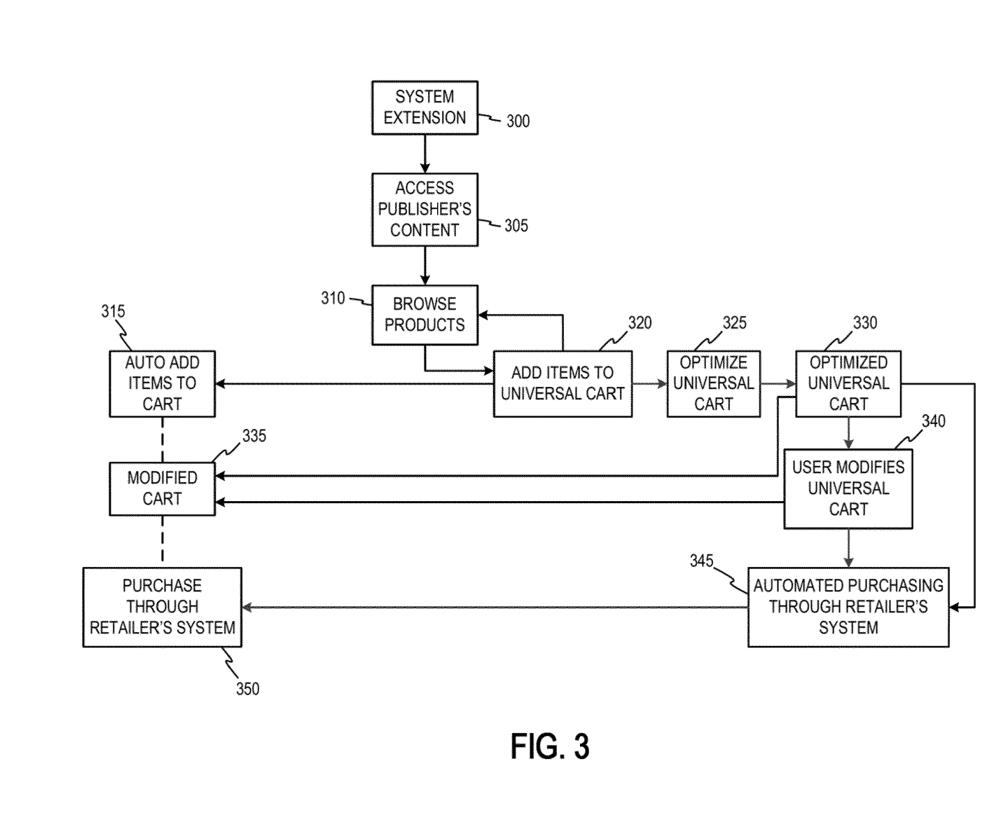

FIG. 3 depicts a flow diagram of an illustrative browsing, optimization, and purchasing process with merchants via the content provider-driven shopping system according to an embodiment. The process may generally include a computer application, a browser application, or a system extension 300 that is downloaded and installed by a user. As described herein, such a system extension 300 may generally be a browser plugin, an application such as a smartphone app, and/or the like. The user may access 305 a provider's content, such as a blog, an article, a recommended shopping list, and/or the like. In some embodiments, the user may browse 310 one or more products that are provided in connection with the provider's content, and if the user is interested in purchasing one of the products, he/she may add 320 the item to a universal shopping cart. For example, a user may select or deselect one or more items from a collection to add the item(s) to the universal cart. Once the user has added 320 an item into the universal shopping cart, the system extension 300 may automatically replicate 315 that item into the merchant's shopping cart. Every time the user adds 320 an item into the universal shopping cart, the system may automatically provide a snapshot of the item to the user and the best value for the item from a particular merchant. In addition, the system may also provide the second and third runner-up merchants in terms of the total purchase price. Upon proceeding to purchase, the system may optimize 325 the universal shopping cart. The optimization 325 may generally account for restricted or un-restricted discounts, coupons, rewards, loyalty programs, loyalty points, and/or the like to ensure the user receives the lowest possible price and/or the highest possible incentive. Based on the user's actions within the optimized universal shopping cart 330, each merchant's shopping cart 335 may be altered or modified accordingly. Within the optimized universal shopping cart 330, the user may choose to modify 340 or proceed to check out via the system's automated checkout 345. If the user makes modifications 340 to the universal shopping cart, the modifications may also be reflected in the merchant's cart 335. If the user checks out via the automated checkout 345, this may cause the merchant's checkout 350 to proceed accordingly and allow the user to finish the transaction.

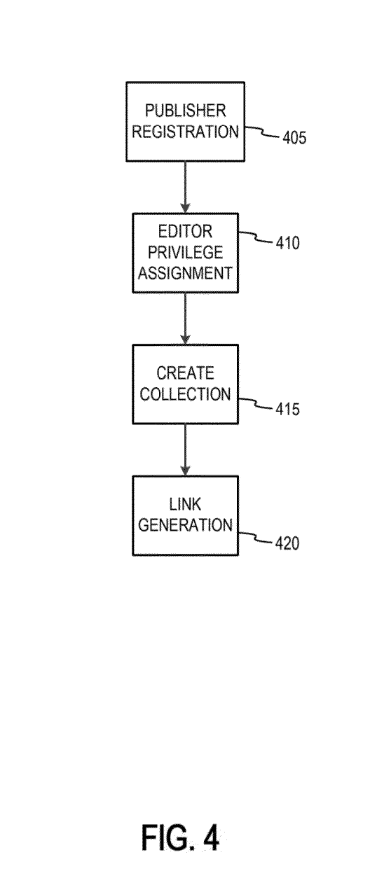

FIG. 4 depicts a flow diagram of an illustrative method completed by a content provider to register and publish content via the system described herein according to an embodiment. The content provider may join the system by registering 405, similar to a typical registration process. Upon registering, the content provider may be provided with standard user access permissions, similar to that of a registered consumer. The content provider may be required to provide information to register 405, such as, for example, an email address, a password, a payment address, a social networking account, and/or the like. Registration 405 may require the content provider to download and/or install software on his/her electronic device, such as, for example, installing a browser plugin or installing a smartphone app.

In some embodiments, once the content provider has registered 405 with the system, a system administrator and/or the like may approve the provider and assign 410 an editor privilege to the provider. The editor privilege may generally elevate the content provider from a standard system user (for example, one that merely makes purchases and creates collections for personal use or sharing with limited friends) to an editor user, which may allow the content provider to publish his/her content on the system and expose it to the entire user community.

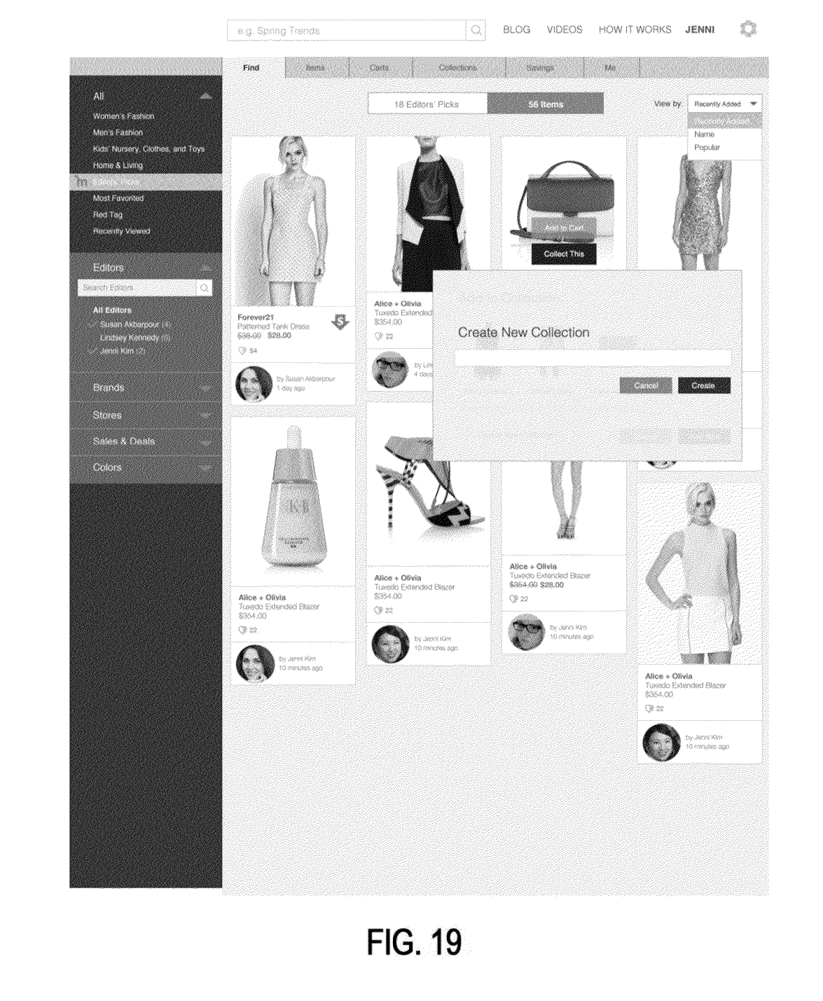

In various embodiments, a registered 405 and privileged 410 content provider may create 415 one or more collections on the system. Creation 415 of collections is not limited by this disclosure, and may generally include providing any type of content that may or may not include one or more products that are offered for sale by a merchant. For example, in some embodiments, the content provider may create 415 a blog entry containing a collection of suggested clothing for an upcoming season. The blog entry may highlight articles of clothing suggested by the content provider. In particular embodiments, the blog entry may not be specific to a particular article of clothing, but may rather provide a general description of an article of clothing (for example, a blog may indicate that red scarves are the latest fashion trend, and/or may provide specific examples of recommended red scarves). In such embodiments, the system may determine clothing options from the blog entry, such as by searching for articles of clothing matching the description in the blog entry, as described in greater detail herein. In other embodiments, the content provider may provide specific articles of clothing (for example, a particular Burberry® scarf) that are recommended. In such embodiments, the system may determine which merchants sell the specific articles of clothing, as described in greater detail herein. In yet other embodiments, the content provider may provide specific articles of clothing that are recommended, and the system may determine certain alternatives to the specific articles of clothing. In some embodiments, the content provider may create a collection of items selected from one or more sources. Illustrative sources may include, but are not limited to, other collections stored on the system (such as by other users), a catalog of items provided by the system (such as the marketplace described herein), merchant websites, and/or the like. A screenshot of an illustrative collection creation page is provided in FIG. 19.

In some embodiments, the system may provide a mobile application, a web application, or a browser extension to the content provider that allows the content provider to browse the Internet, the marketplace previously described herein, and/or the like, and easily obtain items for his/her content. When the content provider reaches a webpage or a marketplace page containing a product the content provider desires to add to the content, he/she may access a feature in the app or browser extension that automatically adds the page or a portion thereof to the content. For example, the content provider may click on a button or a link within the app or browser extension. When the button or link is clicked, the app or software extension may be configured to record information regarding the webpage and/or marketplace page. Illustrative information may include, but is not limited to, a uniform resource locator (URL) for the webpage, webpage metadata, identification of a merchant, identification of a publisher, identification of one or more products contained on the webpage, identification of a price for each of the one or more products contained on the webpage, identification of previously cataloged items, identification of items located on the marketplace, and identification of other associated webpages (such as, for example, other webpages located on a website containing the webpage). In some embodiments, the content provider may not need the app or browser extension. Rather, a button or a link may be embedded in the webpage. The button or link may be configured such that, when a user clicks on the button/link, the information regarding the webpage is automatically sent to the system for cataloging, for the user to add to his/her content, and/or the like, as described herein.

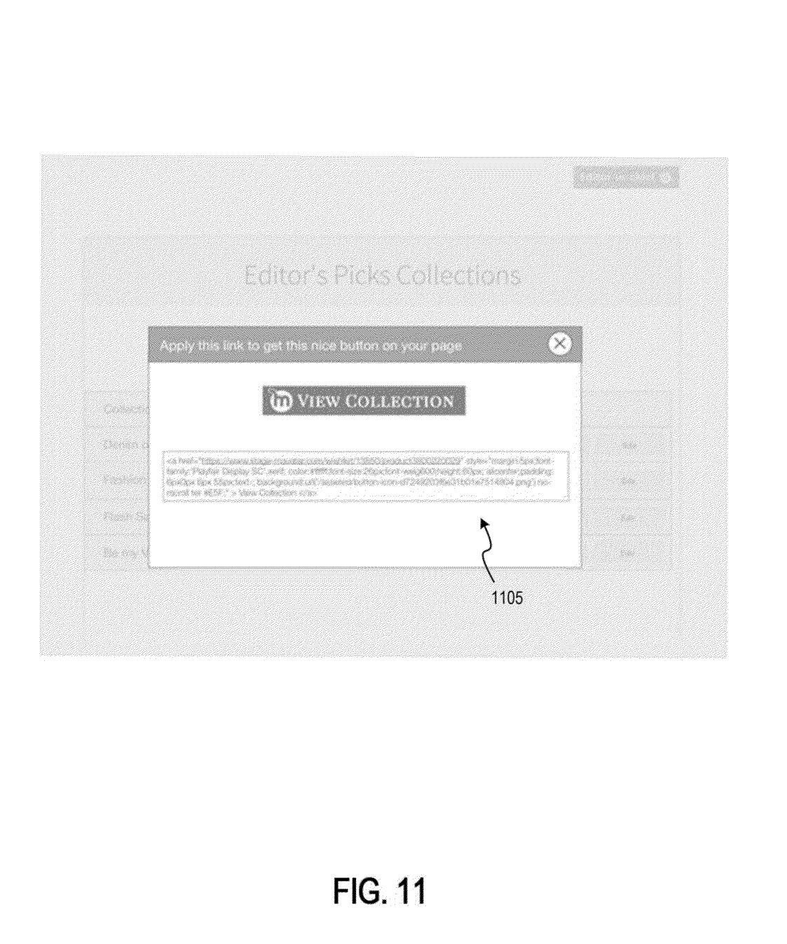

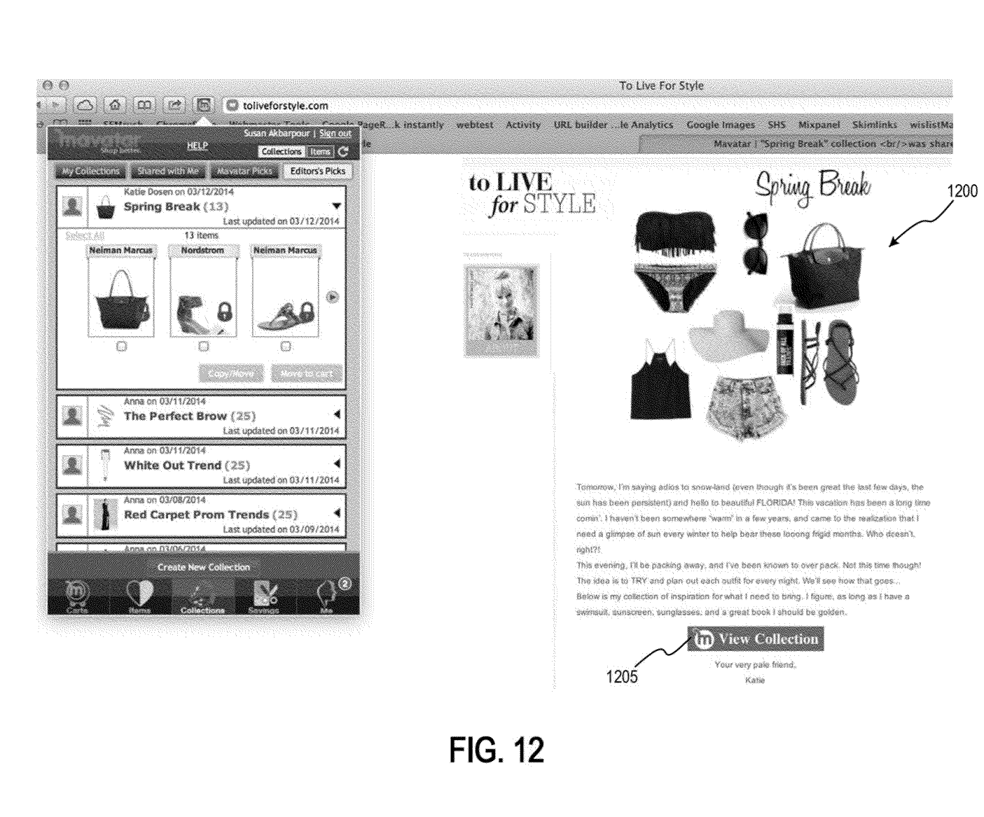

Referring back to FIG. 4, once the products are determined, the system may generate 420 one or more links for the products. In some embodiments, the system may generate 420 a link for each product. In other embodiments, the system may generate 420 a link for an entire collection of products. In embodiments where a link is provided for an entire collection, a content provider can copy and paste the link into any print or web-based medium, such as, for example, a blog entry, a social networking publication, an email, a text message, a website, a movie, a video and/or the like. In some embodiments, the link may provide a direct connection to a collection created by the content provider and published by the system. Such link generation may allow for the content provider to avoid obtaining approval from merchants to provide a link to a product, fetching a product feed, embedding coding and/or application programming interfaces (APIs), hyper-linking individual products, and/or other potentially time consuming and technical work. An illustrative link is shown in FIG. 11. In addition, FIG. 12 depicts an illustrative publication provided by the content provider that includes, but is not limited to, the content provider's recommendations for clothing, websites and prices for the various articles of clothing mentioned, and the link. The publication depicted in FIG. 12 may be published at the discretion of the content provider, such as on the system for other users to access and/or on an external webpage, blog, social networking post, email, text mess, and/or the like.

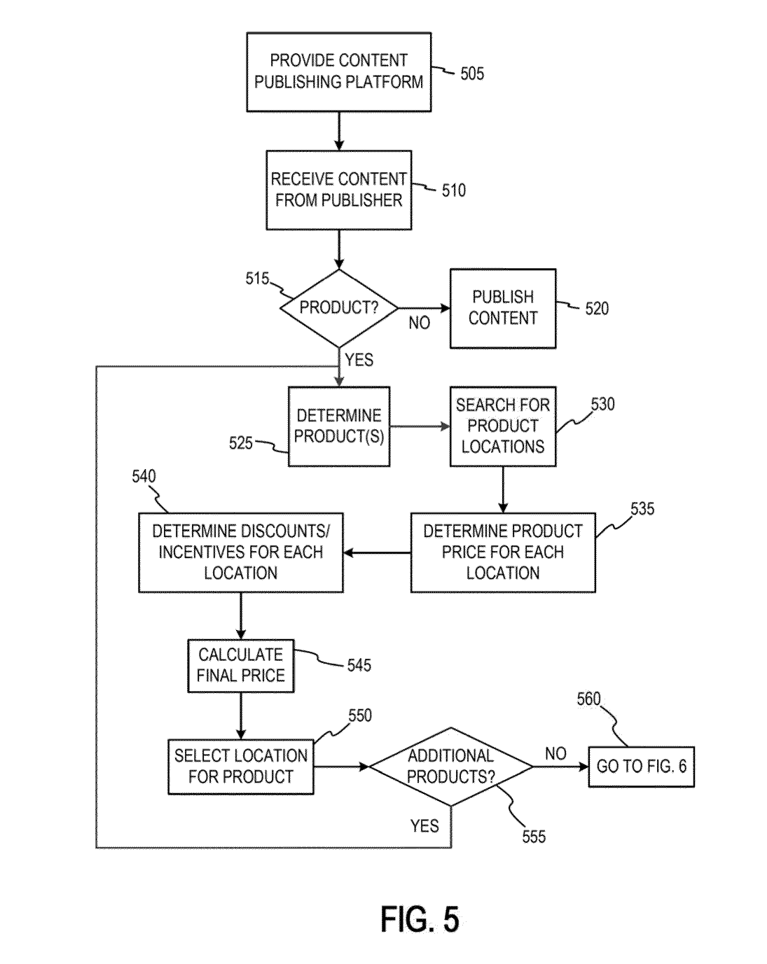

FIG. 5 depicts a flow diagram of an illustrative method of determining one or more products from published content according to an embodiment. The computing device 105 (FIG. 1) may be configured to complete at least a portion of the processes described with respect to FIG. 5. Accordingly, the computing device may receive assistance from one or more other devices in completing the processes. The computing device may provide 505 the content publishing platform. In some embodiments, the content publishing platform may be provided 505 to one or more content providers. The content publishing platform may generally allow a content provider to publish his/or her content. Thus, the content publishing platform may include, for example, a text editor, an HTML editor, a means for uploading photographs, videos, and/or the like, a module for entering the provider's personal information and/or account information to ensure the provider is appropriately credited for consumer purchases, and/or the like. In some embodiments, the content publishing platform may provide the content provider with an ability to create one or more product collections, receive a “collection ID” in the form of a link or button for insertion into a blog, a tweet, a program, a movie, an email, a post, a text message, a social messaging post/pin/wish list, and/or the like. In some embodiments, the “collection ID” may be an equivalent of the link previously described herein. In some embodiments, the “collection ID” may be encoded in a symbology, such as, for example, a 2-dimensional barcode, a 3-dimensional barcode, and the like. When a user accesses the “collection ID”, the user may be directed to a collection of products inside the system, as described in greater detail herein. In some embodiments, the system may provide a “collection ID” once it has received 510 content from the provider. Reception 510 of content may include, for example, one or more inputs from a content provider, such as, for example, selection of one or more items from the marketplace, selection of one or more items offered by a merchant, content uploads, text inputs, and/or the like.

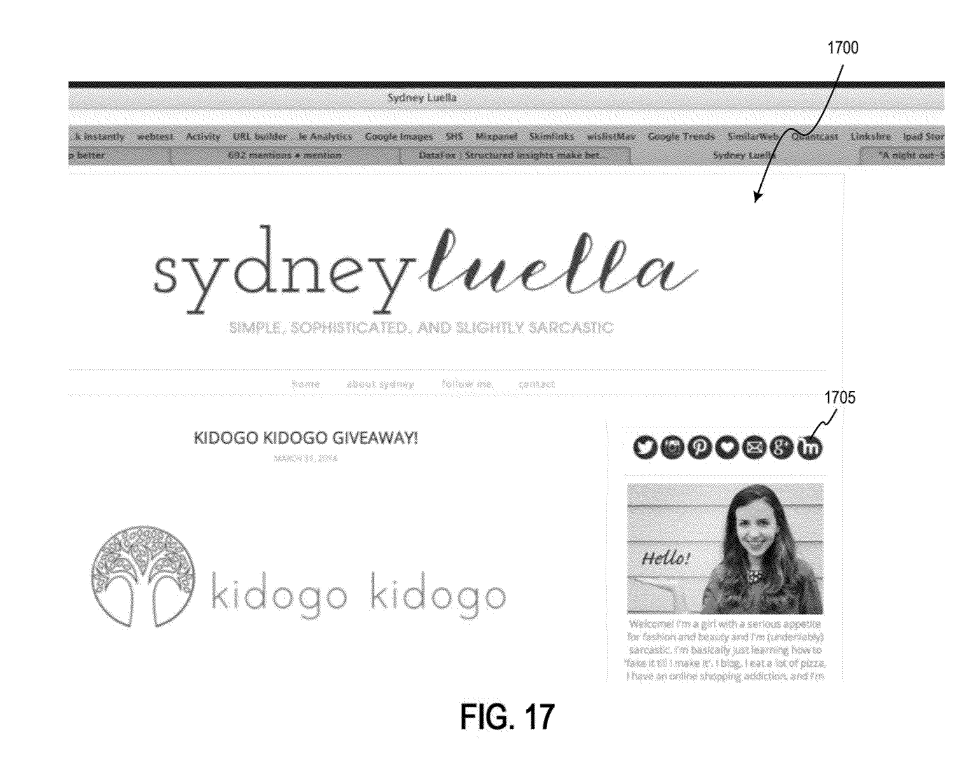

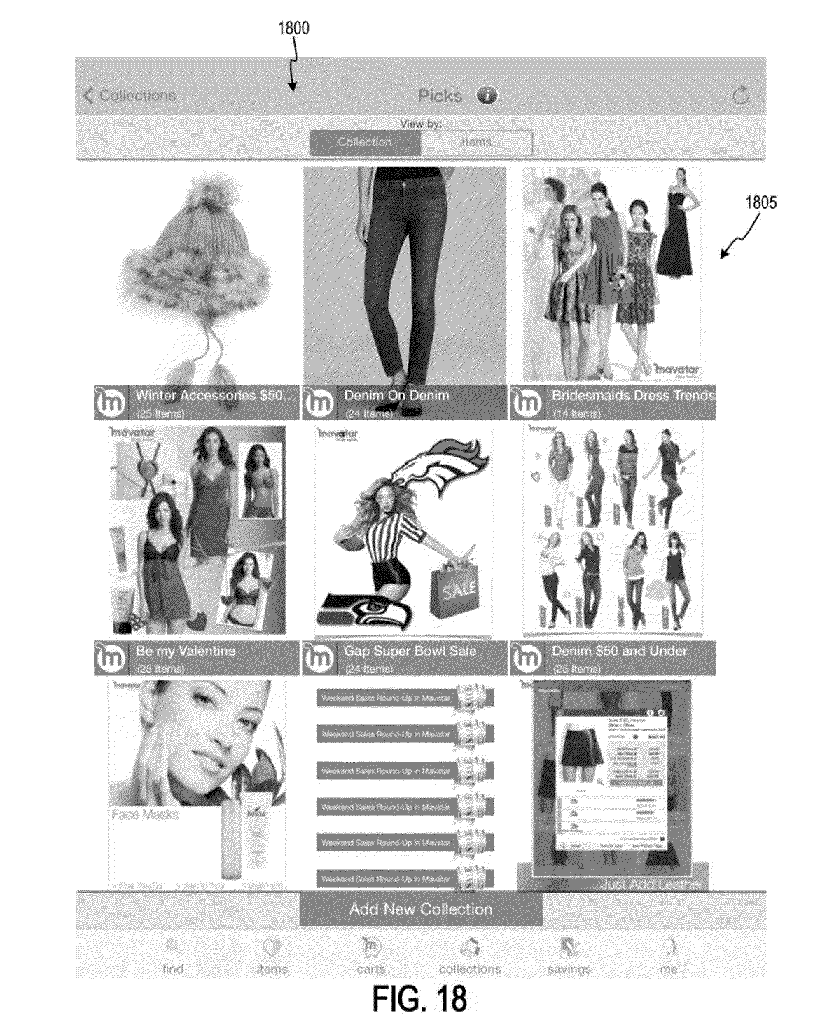

In some embodiments, the system may provide a publisher with a “publisher's collections page” link 1705 (FIG. 17), such as a button, pin, handle, or the like, that a content provider can place on his/her content, social pages, commercials, and/or communications 1700. As shown in FIG. 18, such a “publisher's collections page” link may, for example, allow for the content provider to link all of his/her collections and/or published content 1805 in a single location, such as on a “publisher's collections page” 1800 of the system. The “publisher's collection page” link may be used in any content and in any location on the Internet, such that when a user clicks on the “publisher's collections page” link from any location he/she is instantly transported to all of the publisher's collections, as well as the universal shopping cart and discounts, as described in greater detail herein. Thus, the necessary personal information and VEs may be prepopulated for the user in real time, regardless of the website from which the user accesses the “publisher's collection page” link.

As previously described herein, the content may reference one or more products, either specifically or generally. Thus, the system may determine 515 whether any products are referenced in the content. If the content does not reference any products, the content may be published 520 with no further action taken. If the content does reference at least one product, the system may determine 525 the products referenced in the content. In some embodiments, the system may determine 525 the products by scanning the content. In other embodiments, the system may determine 525 the products by receiving one or more inputs from the content provider, where each input indicates a product or a group of products. For example, the system may provide an entry form to the content provider, and the content provider may enter each product into the entry form. The product may be identified by one or more criteria, such as, for example, name, category, type, collection, designer, size, dimensions, color, price, merchant, a level of price drop, and/or the like. In some embodiments, the product may be identified by an item previously categorized by the system, the content provider from an app or browser plugin while navigating a target website, the user from a link located directly on the target website, or a direct link to the product on a third party website, such as, for example, a designer's website, a merchant's website, and/or the like. In another embodiment, the system may determine 525 the products by receiving selections from the content provider from items previously cataloged by the system.

In various embodiments, the system may search 530 for locations that offer each product for sale. In some embodiments, one or more of the locations may be provided by the content provider, such as, for example, in the form of an URL to a merchant's website that offers the product for sale, which may be obtained when the content provider copies/pastes an URL from the merchant's website, clicks on a button/link located in an app or browser plugin, which causes the URL to be obtained, clicks on a button/link located on a third party website, which causes the URL to be sent to the system, or selections within a marketplace. In some embodiments, the system may search 530 for locations by using an Internet-based search engine. In other embodiments, the system may search 530 for locations by using a proprietary search algorithm. In some embodiments, the system may search 530 merchant websites that are associated with an affiliate marketing provider. In some embodiments, the system may not need to search 530, particularly for previously searched items and/or items located on the marketplace. For each merchant discovered that offers the product for sale, the system may determine 535 a product price. The product price may include any additional charges, such as, for example, sales tax, luxury tax, shipping fees, handling fees, and/or the like.

In addition to the product price, the system may determine 540 whether any discounts and/or incentives are offered by each merchant with the purchase of the product. More particularly, the system may determine 540 a combination of one or more discounts and/or one or more incentives that result in a maximum discount and/or incentive for a particular merchant. Discounts and/or incentives are not limited by this disclosure, and may generally be any type of discount and/or incentive that reduces the purchase price, reduces the additional fees, provides a free item, provides a rebate, and/or the like. Illustrative discounts and/or incentives may include, but are not limited to, a percentage off a particular item, a percentage off a total purchase price, a dollar amount off a particular item, a dollar amount off a total purchase price, an offer for free shipping, an offer for a reduced shipping cost, addition of a free product with the purchase of an item, addition of a mail-in rebate with the purchase of an item, and/or the like. In some embodiments, the discounts and/or incentives may be provided only for a particular product and/or for a particular sales amount. In some embodiments, discounts and/or incentives may be provided to a particular combination of products (for example, a user may receive a discount if 2 products are purchased together). In some embodiments, the discounts and/or incentives may be generally provided to any purchaser. In other embodiments, the discounts and/or incentives may be provided to a particular purchaser, such as a targeted purchaser, a purchaser having a rewards account, a purchaser using a particular type of credit card to complete the transaction, and/or the like.

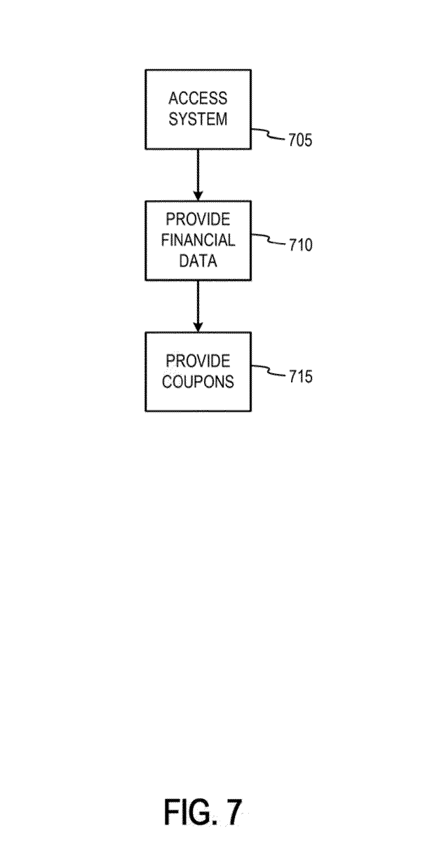

In some embodiments, various discounts and/or incentives may be determined 540 when a user provides a discount and/or incentive, as shown in FIG. 7. As shown in FIG. 7, the user may access the system 705, such as, for example, via a dashboard module or the like. The user may provide 710 financial data into the system for future use, which may include any number of financial accounts such as checking accounts, savings accounts, credit accounts, credit cards, money market accounts, investment accounts, and/or the like. The user may also provide 715 one or more coupons, discounts, rewards, and/or promotions.

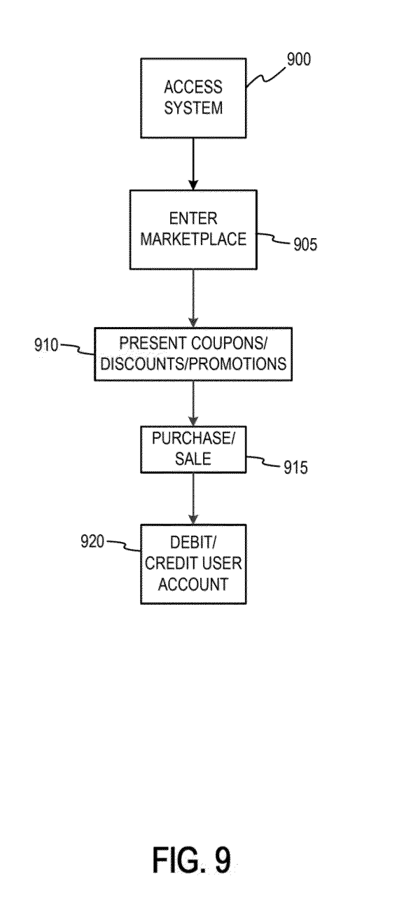

In some embodiments, a user may have an ability to purchase a coupon, a discount, a reward, and/or a promotion for use with the system. Such a process for purchased coupons, discounts, rewards, and/or promotions is described with respect to FIG. 9. A user may access 900 the system, such as, for example, the system's Web site, and may enter 905 into a marketplace. In some embodiments, the marketplace may be an extension or a module of the system. In other embodiments, the marketplace may be a third-party marketplace, such as, for example, Groupon®, LivingSocial®, and/or the like. The user may be presented 910 with one or more coupons, discounts, rewards, and/or promotions that may be available for sale or for trade. Freely available coupons, discounts, rewards, and/or promotions may generally not be available, as the system will account for such coupons, discounts, and/or promotions, as described herein. The user may select and purchase 915 one or more coupons, discounts, rewards, and/or promotions. In some embodiments, the user may purchase 915 the one or more coupons, discounts, rewards, and/or promotions at a set purchase price. In other embodiments, the user may purchase 915 one or more coupons, discounts, rewards, and/or promotions at an auction. In yet other embodiments, the user may purchase 915 one or more coupons, discounts, rewards, and/or promotions by naming a desired purchase price. Upon any purchase or sale of a coupon, a discount, a reward, and/or a promotion, the system may automatically debit 920 the user's account accordingly. Those with ordinary skill in the art will recognize that in some embodiments, a user may sell one or more coupons, discounts, rewards, and/or promotions to one or more other users instead of purchasing the coupons, discounts, rewards, and/or promotions.

Referring back to FIG. 5, once the price has been determined 535 and a maximum discount and/or incentive has been determined 540 for each merchant, a final price for the product at each merchant may be calculated 545. Calculating 545 the final price may generally include subtracting any discounts and/or incentives from the product price. For example, if a product is $500 plus $25 for shipping (total: $525), and a maximum discount for that product provides for 10% off a purchase price and free shipping, the final price may be calculated as $450 ($500−($500×0.10)=$500−$50=$450). In some embodiments, calculating 545 may be completed at the time a user selects various products to purchase, as some discounts and/or incentives may only be applied when a particular combination of products is purchased. A preferred purchase location may be selected 550 for each product based upon the final price. For example, if a product is sold at merchant 1, merchant 2, and merchant 3 for $500, $488.50, and $450, respectively, merchant 3 may be selected as the preferred purchase location because it offers the lowest final price. In some embodiments, a preferred purchase location may be based on a user's preferences, such as, for example, a user may prefer to purchase from a particular merchant because of its frequent shopper program, even if the merchant is not offering the lowest final price.

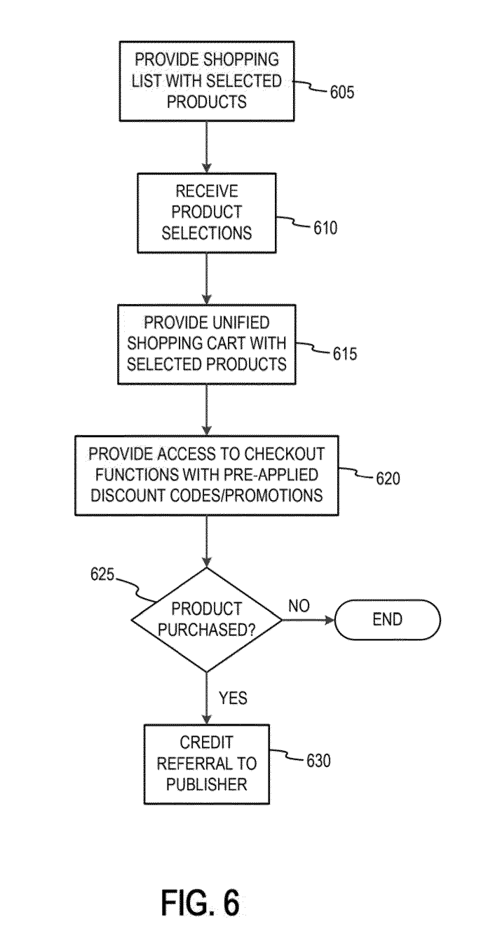

A determination 550 may be made as to whether additional products have been referenced in the content. If additional products have been referenced, the process may repeat at determining 525 the product. If no additional products have been referenced, the system may provide 560 content-driven shopping, as described with respect to FIG. 6.

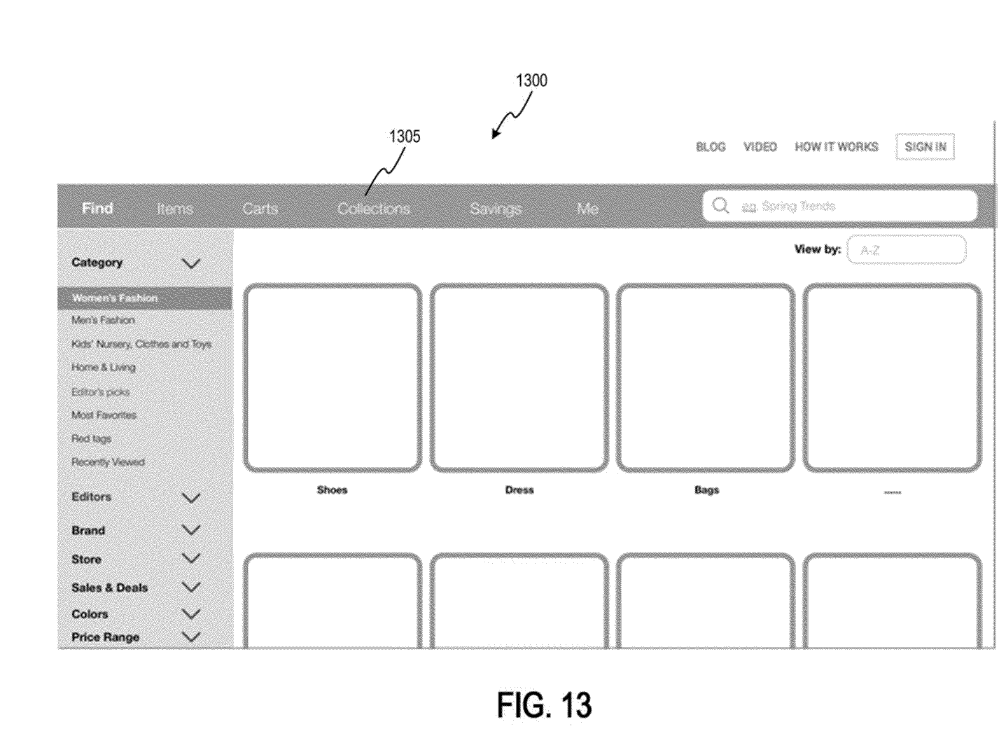

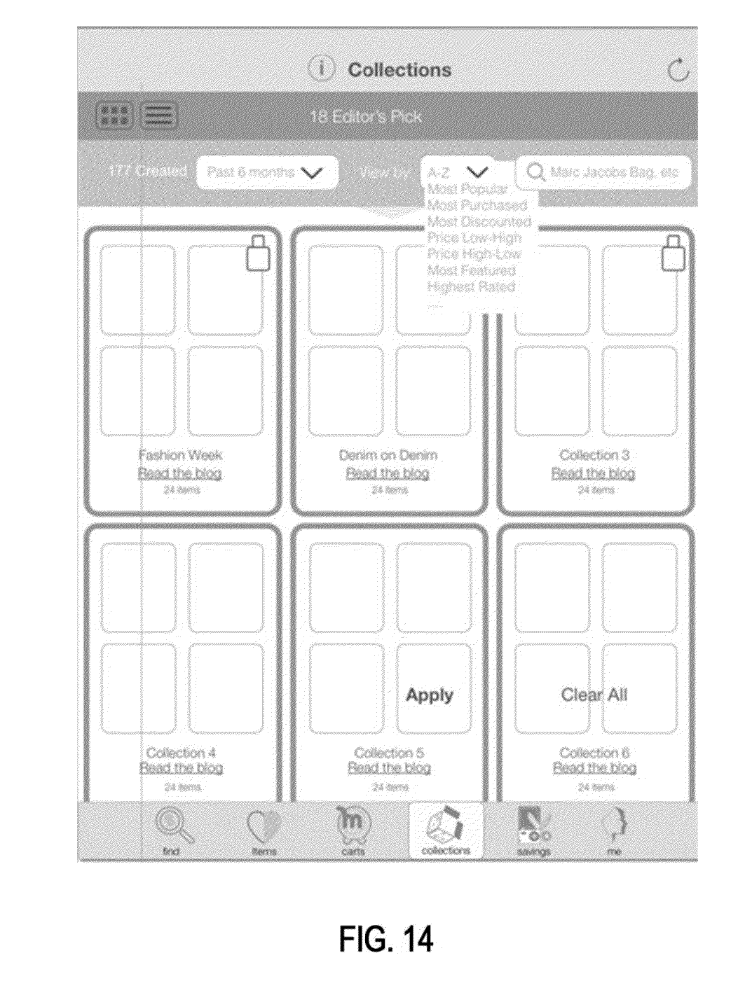

As shown in FIG. 6, the system may provide 605 a link to a shopping list containing one or more of the products selected from the method depicted in FIG. 5. In some embodiments, the link 1105 to the shopping list may be located on a web page, in an application, and/or the like, as described in greater detail herein and shown in an example in FIG. 11. In some embodiments, the link 1105 to the shopping list may be provided to the content producer for any use. Thus, the content producer may decide how to use the link 1105 to the shopping list, such as, for example, deciding what content in which to include the shopping list, deciding a location of the shopping list within the content, and/or the like. Accordingly, the link 1105 may be accessible to a user from within the content provided by the provider. For example, FIG. 12 depicts the link 1205 to the shopping list at the bottom of the content 1200 such that the user reviews all of the content before viewing the link to the provided shopping list. In other embodiments, the shopping list may be accessible within the marketplace 1300 portion of the system, as shown, for example, in FIG. 13. Thus, in instances where a user may not know where to access a content provider's content or in instances where a user is unaware of a content provider's content, the marketplace 1300 may provide access to various content 1305 to assist the user in selecting various products. FIG. 14 depicts a screen shot of such illustrative collections within a store that a user may use to access content provided by a content provider.

As previously described herein, if a user desires to purchase one or more items from the shopping list, he/she may click on a link to view the collection of products, and select products from the list that are desired, and move them to his/her personal universal cart. In some embodiments, a user may desire to save products for future purchase to current or new collection(s). The system may be configured to store the user's product selections, but not complete additional steps described below until the user decides to move forward with the purchase. Such a decision may be completed by the user by accessing a “saved items” cart and/or the like. In some embodiments, a “saved items” cart may be private and only accessible to the user. In other embodiments, a “saved items” cart may be partially private, where it is only accessible to the user and anyone designated by the user to view the cart. In other embodiments, a “saved items” cart may be public and accessible to anyone.

Returning to FIG. 6, once the user has selected one or more products for immediate purchase or has decided to purchase products previously selected and saved for later, the product selections may be received 610 by the system, which may be configured to provide 615 a unified shopping cart containing the selected products, as described in greater detail herein. The system may further provide 620 access to each merchant's checkout functions with any pre-applied coupons, discount codes, rewards, and/or promotions so that the user does not have to discover and enter the information. In some embodiments, a user's billing and/or contact information may also be pre-filled in the merchant's checkout functions so that the user does not have to enter the information. In other embodiments, the system may process the discounts, the shipping information, and the payment information and forward the information to the merchant for fulfillment instead of providing 620 access to each merchant's checkout function. As a result, the user may receive a single charge and a single receipt for all of the items in his cart, regardless of the merchant from which the items were purchased.

The system may determine 625 whether a product has been purchased, and if so, the system may credit 630 a referral to the content provider. Determination 625 may generally include communicating with the merchant to receive confirmation from the merchant about whether a transaction was completed. For example, in some embodiments, the system and the merchant may be members of the same affiliate marketing provider, which may allow for transmission of purchase information and issuance of referral bonuses, credits, and/or the like. In some embodiments, when a user selects a product from a collection, information about that product may be inserted into tracking records that are sent to the merchant. If the user decides not to purchase the product, but rather to save the product for future purchase (as described herein), the identification information relating to the content publisher's initial referral may be carried with the product. Eventually, when the user decides to purchase the product, the information may be inserted in a record that is sent to the merchant. The record may be allocated to the system by an affiliate network or the merchant. When the sale is consummated by the merchant, the information contained in the record is fetched by the system, either directly from the merchant or via the affiliate network. The information may include evidence of sale consummation and attribution to the content provider that provided the referral to the merchant. The information may be specific to the content provider, thereby avoiding instances where two different content providers provide a link to the same product. In this manner, no confusion may arise regarding which content provider actually referred the user to the merchant. Similarly, when a content provider republishes an already published product by another content provider, the system may be configured to track the origination collection and attribute the referral correctly. Therefore, the system may provide an incentive to content providers to introduce other content providers to the system by correctly attributing all products sold and allocating a percentage commission of lower level content providers to the referring content provider. Crediting 630 the referral to the content provider may generally include acknowledging that the content provider's content led to a user's purchase of a particular item. Thus, the content provider may receive compensation, an award, a change in status, and/or the like for the referral. In some embodiments, the type of credit 630 may depend upon the affiliate marketing provider, the merchant, various agreements between the merchant, the affiliate marketing provider, and the content provider, and/or the like.

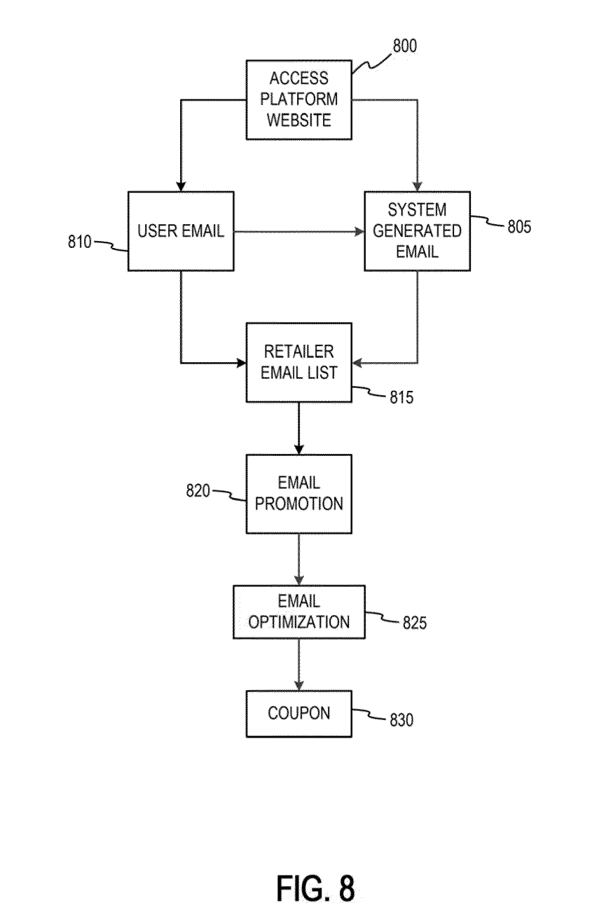

FIG. 8 depicts a flow diagram of an illustrative email registration, management, and optimization process according to an embodiment. The process described with respect to FIG. 8 may generally be used to register a user with the system to make product purchases and receive discounts, as described herein. In some embodiments, the process may also be used to ensure the system receives coupons that are customized for a particular user, such as private coupons and/or the like. Upon accessing 800 the system's website, a user may choose to obtain a system generated email 805 or continue to use her own email 810 for all future correspondence with merchants. The selected email address may be used by the merchant for transmission of various coupons, discounts, rewards, loyalty points, and/or promotions and may be placed on an email list 815. When a merchant sends 820 targeted promotions to selected consumers, the coupons may be automatically aggregated and organized 825 for the user without any further input from the user. The user may be able to view the full promotion that was sent and all active offers or coupons offered by the merchant 830 via the system.

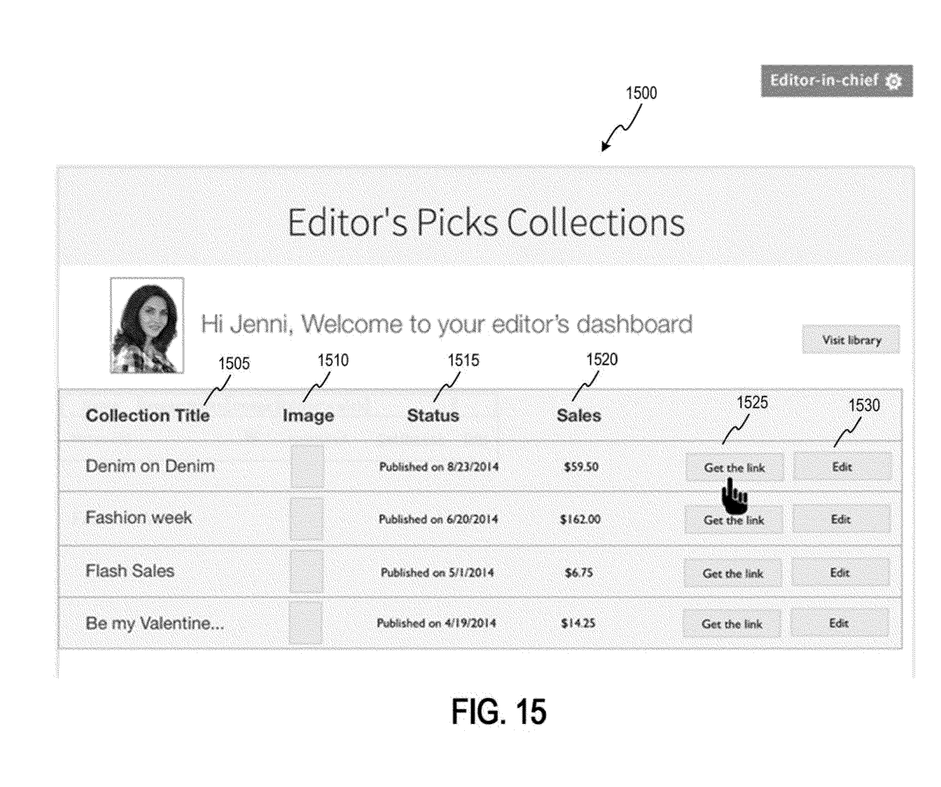

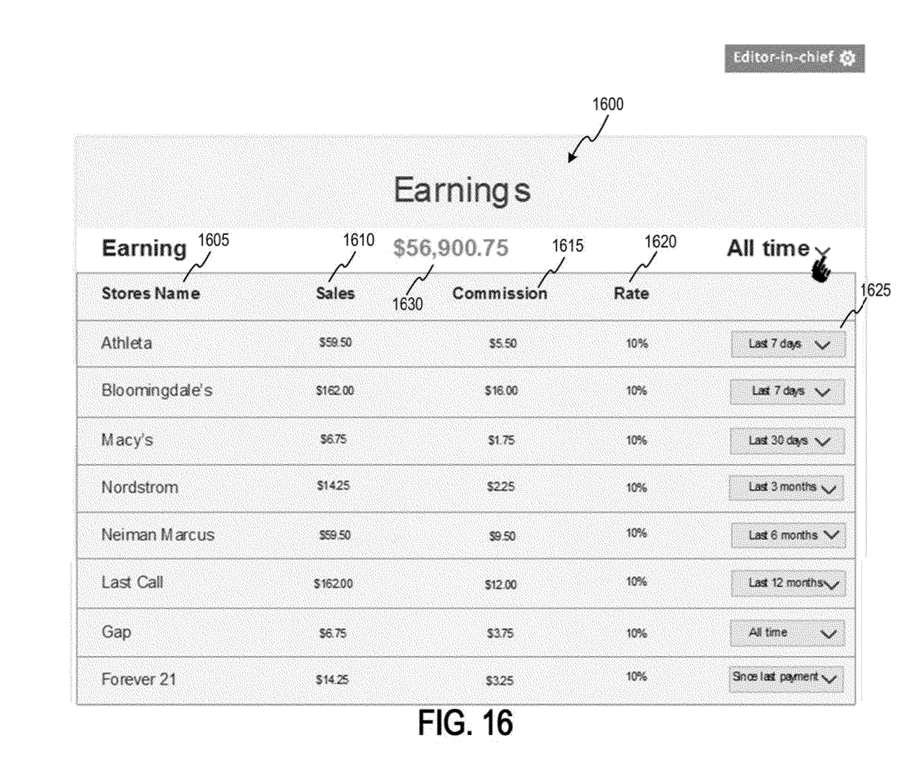

In some embodiments, the system may provide a dashboard that displays an overview of the various content that has been provided by the content provider. As shown in FIG. 15, the dashboard 1500 may contain, for example, a title 1505 of each collection, an illustrative image 1510 of each collection, a status 1515 of each collection, an amount of sales 1520 attributed to each collection, access to the link 1525 for each collection and/or the original blog, and means 1530 for editing each collection. The status 1515 of each collection may contain information such as when the collection was published, how many times it has been viewed, whether it has been updated, whether it has been removed, and/or the like. In some embodiments, the amount of sales 1520 may correspond to the credits that the content provider receives for leading a user to purchase an item from a merchant, as described in greater detail herein. In other embodiments, the amount of sales 1520 may correspond to an amount the merchant sold that came from direct referrals using the systems and methods described herein. FIG. 16 depicts a more detailed view of the amount of sales for each collection provided by the content provider. As shown in FIG. 16, the detailed view 1600 may include, for example, a merchant name 1605, an amount the merchant sold 1610, an amount paid in commission to the content provider 1615, a rate at which commission is paid 1620, and a time period selection means 1625. In some embodiments, the detailed view 1600 may also contain a total amount sold 1630 and/or a total amount of commissions paid to the content provider. In some embodiments, the commission paid to the content provider may reflect a commission paid by a merchant, minus one or more fees and/or deductions retained by the system.

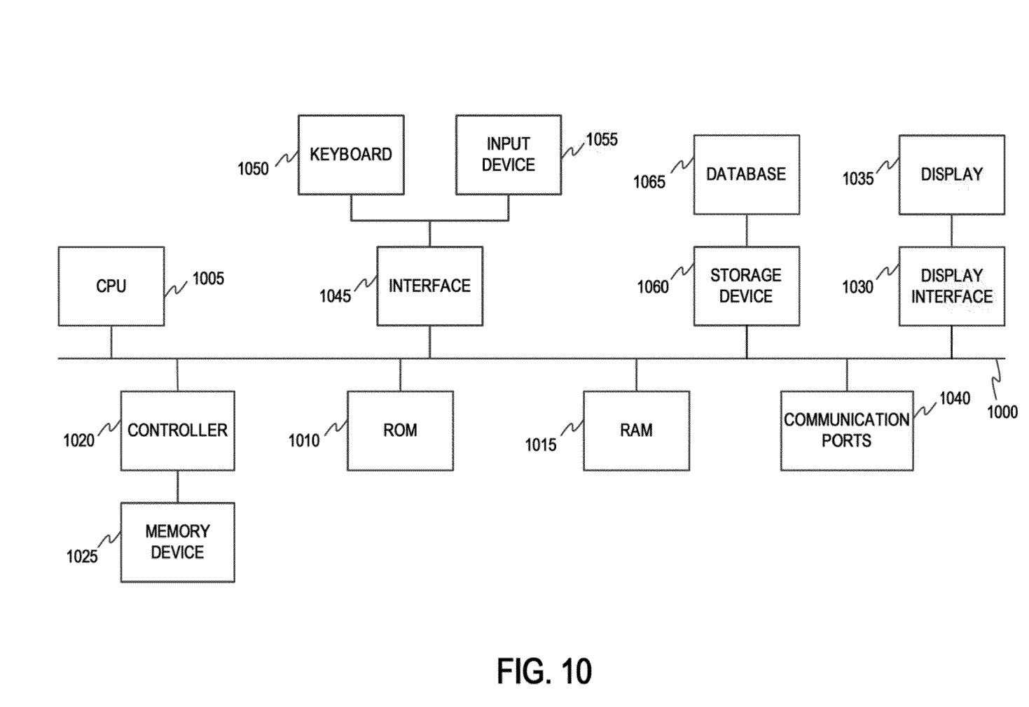

FIG. 10 depicts a block diagram of illustrative internal hardware that may be used to contain or implement program instructions, such as the process steps discussed herein, according to various embodiments. A bus 1000 may serve as the main information highway interconnecting the other illustrated components of the hardware. A CPU 1005 is the central processing unit of the system, performing calculations and logic operations required to execute a program. The CPU 1005, alone or in conjunction with one or more of the other elements disclosed in FIG. 10, is an illustrative processing device, computing device or processor as such terms are used within this disclosure. Read only memory (ROM) 1010 and random access memory (RAM) 1015 constitute illustrative memory devices (such as, for example, processor-readable non-transitory storage media).

A controller 1020 interfaces with one or more optional memory devices 1025 to the system bus 1000. These memory devices 1025 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 1010 and/or the RAM 1015. Optionally, the program instructions may be stored on a tangible computer-readable medium such as a compact disk, a digital disk, flash memory, a memory card, a USB drive, an optical disc storage medium, such as a Blu-Ray™ disc, and/or other non-transitory storage media.

An optional display interface 1030 may permit information from the bus 1000 to be displayed on the display 1035 in audio, visual, graphic, or alphanumeric format, such as the interface previously described herein. Communication with external devices, such as a print device, may occur using various communication ports 1040. An illustrative communication port 1040 may be attached to a communications network, such as the Internet, an intranet, or the like.

The hardware may also include an interface 1045 which allows for receipt of data from input devices such as a keyboard 1050 or other input device 1055 such as a mouse, a joystick, a touch screen, a remote control, a pointing device, a video input device and/or an audio input device.

The hardware may also include a storage device 1060 such as, for example, a connected storage device, a server, and an offsite remote storage device. Illustrative offsite remote storage devices may include hard disk drives, optical drives, tape drives, cloud storage drives, and/or the like. The storage device 1060 may be configured to store data as described herein, which may optionally be stored on a database 1065. The database 1065 may be configured to store information in such a manner that it can be indexed and searched, as described herein.

The computing device of FIG. 10 and/or components thereof may be used to carry out the various processes as described herein.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A system comprising:
a processor; and
a non-transitory, processor-readable storage medium, wherein the non-transitory, processor-readable storage medium comprises one or more programming instructions that, when executed, cause the processor to:
receive content from a provider via a content publishing platform;
determine one or more products from the content;
for each product:
determine one or more merchants offering the product for sale, and
determine a price for the product from each merchant;
determine one or more discounts or incentives offered by each merchant; and
for each product, select a merchant of the one or more merchants based on the price of the product from the merchant and the one or more discounts or incentives offered by the merchant.

2. The system of claim 1, wherein the one or more programming instructions that, when executed, cause the processor to select a merchant further comprise one or more programming instructions that, when executed, cause the processor to select a merchant offering a lowest total price, wherein the lowest total price is a lowest price based on the price of the product minus the one or more discounts or incentives.

3. The system of claim 1, wherein the one or more programming instructions that, when executed, cause the processor to select a merchant further comprise one or more programming instructions that, when executed, cause the processor to select a merchant based on a preferred merchant selection provided by a user.

4. The system of claim 1, further comprising one or more programming instructions that, when executed, cause the processor to provide the content publishing platform to the provider prior to receiving the content.

5. The system of claim 1, wherein the one or more programming instructions that, when executed, cause the processor to determine one or more products from the content comprises one or more programming instructions that, when executed, cause the processor to receive one or more inputs from the provider, wherein the one or more inputs correspond to the one or more products.

6. The system of claim 1, wherein the content publishing platform comprises at least one of a blog entry, a social networking publication, an email, a text message, a website, a movie, and a video.

7. The system of claim 1, wherein the product comprises at least one of an article of clothing, a fashion accessory, a household good, an electronic device, a car, a flight, a hotel reservation, an event ticket, and property.

8. A method comprising:
receiving, by a processor, content from a provider via a content publishing platform;
determining, by the processor, one or more products from the content;
for each product:
determining, by the processor, one or more merchants offering the product for sale, and
determining, by the processor, a price for the product from each merchant;
determining, by the processor, one or more discounts or incentives offered by each merchant; and
for each product, selecting, by the processor, a merchant of the one or more merchants based on the price of the product from the merchant and the one or more discounts or incentives offered by the merchant.

9. The method of claim 8, wherein selecting, by the processor, the merchant further comprises selecting, by the processor, a merchant offering a lowest total price, wherein the lowest total price is a lowest price based on the price of the product minus the one or more discounts or incentives.

10. The method of claim 8, wherein selecting, by the processor, the merchant further comprises selecting, by the processor, the merchant based on a preferred merchant selection provided by a user.

11. The method of claim 8, further comprising providing, by the processor, the content publishing platform to the provider prior to receiving the content.

12. The method of claim 8, wherein determining, by the processor, one or more products comprises receiving one or more inputs from the provider, wherein the one or more inputs correspond to the one or more products.

13. The method of claim 8, wherein the content publishing platform comprises at least one of a blog entry, a social networking publication, an email, a text message, a website, a movie, and a video.

14. The method of claim 8, wherein the product comprises at least one of an article of clothing, a fashion accessory, a household good, an electronic device, a car, a flight, a hotel reservation, an event ticket, and property.

15. A system comprising:
a processor; and
a non-transitory, processor-readable storage medium, wherein the non-transitory, processor-readable storage medium comprises one or more programming instructions that, when executed, cause the processor to:
provide a shopping list of one or more products, wherein each of the one or more products corresponds to a product identified in published content and wherein each of the one or more products is selected from a particular merchant offering the product at a lowest price based on a final price and one or more discounts or incentives;
receive one or more product selections from the shopping list;
provide a unified shopping cart containing the one or more product selections; and
for each product, provide access to the particular merchant's checkout functions with the one or more discounts or incentives pre-applied.

16. The system of claim 15, further comprising one or more programming instructions that, when executed, cause the processor to:
determine that a product has been purchased from a merchant; and
provide a referral credit to a provider of the published content.

17. A method comprising:
providing, by a processor, a shopping list of one or more products, wherein each of the one or more products corresponds to a product identified in published content and wherein each of the one or more products is selected from a particular merchant offering the product at a lowest price based on a final price and one or more discounts or incentives;
receiving, by the processor, one or more product selections from the shopping list;
providing, by the processor, a unified shopping cart containing the one or more product selections; and
for each product, providing, by the processor, access to the particular merchant's checkout functions with the one or more discounts or incentives pre-applied.

18. The method of claim 17, further comprising:
determining, by the processor, that a product has been purchased from a merchant; and
providing, by the processor, a referral credit to a provider of the published content.
